(19) United States
(12) Patent Application Publication
(10) Pub. No.: US 2002/0183201 A1
(43) Pub. Date: Dec. 5, 2002

(54) Adsorbents for use in regenerable adsorbent fractionators and methods of making the same

(76) Inventors: James W. Barnwell, Ocala, FL (US); Donald H. White JR., Ocala, FL (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/846,106

(22) Filed: May 1, 2001

(51) Int. Cl. B01J 20/08

(52) U.S. Cl. 502/415

(57) ABSTRACT

Adsorbents for use in regenerable adsorbent fractionators. The adsorbent may be in the form of composite adsorbent wherein each granule is an admixture of tabular alumina particles and adsorbent medium particles or the adsorbent may be in the form of an admixture of tabular alumina granules and adsorbent medium granules. The present invention also relates to methods of making the adsorbents as well as regenerable adsorbent fractionators comprising the adsorbents

### FIELD OF THE INVENTION

The present invention relates to adsorbents for use in regenerable adsorbent fractionators. The present invention also relates to methods of making the adsorbents as well as regenerable adsorbent fractionators comprising the adsorbents.

### BACKGROUND OF THE INVENTION

Adsorbents are materials that have the ability to hold molecules of other substances on their surfaces. Adsorbents include both naturally occurring materials such as activated carbon and natural zeolites and synthetic materials such as activated alumina and molecular sieves. Adsorbents may be, for example, in the form of irregular granules (granular), beads (round), pellets (cylindrical or lobed), and tablets.

Adsorbents are typically used in adsorbent beds of regenerable adsorbent fractionators. Regenerable adsorbent fractionators are systems that separate the components of a fluid such as a liquid or a gas. Examples of regenerable adsorbent fractionators are, pressure swing absorbers (PSA) and thermal swing absorbers (TSA). The pressure swing adsorption process and the temperature swing adsorption process have been extensively employed in the fractionation of air and other gases. The ability of the pressure swing adsorption and the thermal swing adsorption processes to efficiently and economically separate the components of a mixed-gas stream has made them the preferred methods for many process applications. For example, in the case of a pressure swing absorber, the pressure swing absorber is made up of two or more pressure vessels containing an adsorbent in adsorbent beds with interconnecting piping and valving and an automated control device. The adsorbent is typically selected on the basis of the application requirements.

There are many known processes for both the preparation and use of adsorbents. Among them are the following.

U.S. Pat. No. 3,960,771 discloses a composite adsorbent comprising particles of activated clay and fine powder of active carbon randomly adhered on the surfaces of the particles.

U.S. Pat. No. 5,858,900 discloses a composition suitable for admixture with refractory grains to make a refractory monolithic formulation consisting essentially of: 2 to 10 parts by weight of activated alumina; 0.25 to 1 parts by weight of an additive material which comprises at least one of an alumino-silicate-phosphate compound; a resin derived from an aldehyde and either an amine or an aromatic hydroxy compound; cellulose; polyethylene glycol(s); and methoxy polyethylene glycols; 0 to 50 parts by weight of fine alumina; 0 to 10 parts by weight of fine silica; 0 to 1 parts by weight of a dispersant; and 0 to 1 parts by weight of calcium aluminate cement.

U.S. Pat. No. 4,788,519 discloses an exhaust-control device to adsorb the energy of exhaust gases released during operation of a circuit-interrupting device which includes a first heat adsorbing medium and a second heat adsorbing medium.

U.S. Pat. No. 3,965,452 discloses an exhaust control device to adsorb the energy of exhaust gases released during operation of a circuit interrupting device such as a power fuse or an expulsion fuse. The exhaust gas is passed through particles of adsorbent material such as activated alumina that further cools the gases and adsorbs water vapor and metallic vapor from the exhaust gases.

U.S. Pat. Nos. 3,996,335 and 4,100,107 disclose desulfurization of a fuel gas wherein sulfur compounds contained in fuel gases produced from the gasification of coal or petroleum residue are removed at above about 1600° F. temperatures by contacting the gas with an adsorbent material comprising a strong, macroporous particulate solid support containing molten metal carbonate, such as potassium carbonate, within its pores.

U.S. Pat. No. 4,950,311 discloses a heaterless adsorption process for the purification and fractionation of an air feed in the absence of pretreating the air feed to remove moisture or other contaminants wherein an adsorbent is used in the fractionation.

U.S. Pat. No. 5,917,136 discloses a pressure swing adsorption process for adsorbing carbon dioxide from a gaseous mixture containing carbon dioxide wherein an adsorbent formed by impregnating alumina with a basic solution having a pH of 9 or more is used to adsorb carbon dioxide from the gaseous mixture.

U.S. Pat. No. 5,744,412 discloses a composition and process for making an insulating refractory material. The composition includes calcined alumina powder, flash activated alumina powder, an organic polymeric binder and a liquid vehicle which is preferably water.

U.S. Pat. No. 4,983,190 discloses a pressure-swing adsorber using molecular sieve to fractionate toxic vapors from air.

Although processes for the preparation and use of adsorbents as discussed above are known, there is a continual search for ways in which to improve the performance, efficiency and design of regenerable adsorbent fractionators and the adsorbents that are used therein. It is expected that the adsorbent of the present invention will result in such improvements as compared to other existing adsorbents.

### SUMMARY OF THE INVENTION

The present invention relates to adsorbents for use in regenerable adsorbent fractionators. In one embodiment of the present invention, the adsorbent is in the form of composite adsorbent granules wherein each granule is an admixture of tabular alumina particles and adsorbent medium particles wherein the adsorbent medium is other than tabular alumina. Preferably, each composite adsorbent granule has a center comprised of tabular alumina particles and a surface surrounding the center comprised of adsorbent medium particles wherein the adsorbent medium is other than tabular alumina. Activated alumina is a preferred adsorbent medium.

In another embodiment of the present invention, the adsorbent is in the form of an admixture of tabular alumina granules and adsorbent medium granules.

The present invention is also directed toward methods of making the adsorbents as well as regenerable adsorbent fractionators comprising the adsorbents. Preferred regenerable adsorbent fractionators are pressure swing absorbers and temperature swing absorbers. Pressure swing absorbers are particularly preferred.

### DESCRIPTION OF THE PREFERRED EMBODIMENTS

The present invention relates to adsorbents for use in regenerable adsorbent fractionators. The term “adsorbent,” as used in the context of the present invention, refers to a natural or synthetic material that has the ability to hold molecules of other substances on its surfaces. Adsorbents are typically present in the adsorbent beds of the fractionators. The term “regenerable adsorbent fractionator” as used in the context of the present invention refers to a system that separates the components of a fluid such as a liquid or gas. Regenerable adsorbent fractionators may be used, for example, in a process for drying compressed air or for separating gases such as in the removal of toxic gases from air or water vapor from natural gas. Preferred regenerable adsorbent fractionators for use with the adsorbent of the present invention include, but are not limited to, pressure swing absorbers (PSA) and thermal swing absorbers (TSA).

In one embodiment of the present invention, the adsorbent is in the form of an admixture of tabular alumina granules and adsorbent medium granules. In another embodiment of the present invention, the adsorbent is in the form of composite adsorbent granules wherein each granule is comprised of tabular alumina particles and adsorbent medium particles wherein the adsorbent medium is other than tabular alumina. Preferably, the composite adsorbent granule has a center comprised of tabular alumina particles and a surface surrounding the center comprised of adsorbent medium particles wherein the adsorbent medium is other than tabular alumina.

The term “granule,” as used in the context of the present invention, refers to an agglomeration of particles. The term “granule,” as used herein, encompasses all types, shapes, sizes and configurations of particles including, but not limited to, pellets, tablets, irregular granules and beads. The adsorbent granules of the present invention can be either untreated or impregnated with a chemical reactant for specific applications.

Other materials which may also be present in the adsorbent granules of the present invention to enhance the heat retaining property of the adsorbent granules include, but are not limited to, gamma alumina, delta kappa alumina, chi alumina, theta alumina, boehmite, other crystalline aluminas, microsilica, mullite which is a chemical composite of alumina and silica, an allophane or clay. Even pure metals such as iron, copper and aluminum may be used to improve heat retention in the adsorbent granules.

The term “particle,” as used in the context of the present invention, refers to a discrete portion of a granule. A particle may be of any shape, size or configuration.

The term “adsorbent medium,” as used in the context of the present invention, refers to a material that has the ability to hold molecules of other substances on its surfaces as does an adsorbent, however, it is just one component of the “adsorbent” of the present invention. Adsorbent mediums that are suitable for use in the present invention include, but are not limited to, activated alumina, silica gel, molecular sieve, adsorbent clay, activated carbon, and mixtures thereof. Preferably, the adsorbent medium is activated alumina. Such suitable adsorbent media are commercially available. Molecular sieves, for example, are commercially available from UOP. Activated alumina is commercially available, for example, from Alcoa and Rhone-Poulenc Chimie. Silica gel is commercially available, for example, from W. R. Grace & Co. The typical granule density for activated alumina is 86 lb/ft³ (1378 kg/m³), for silica gel is 75 lb/ft³ (1201 kg/m³), for molecular sieves is 70 lb/ft³ (1121 kg/m³), for activated carbon is 46 lb/ft³ (737 kg/m³).

In the admixture, the tabular alumina granules and the adsorbent medium granules may be present in any proportion. However, preferably the admixture comprises 5% to 95% by weight of tabular alumina granules and 95% to 5% by weight of adsorbent medium granules. More preferably, the admixture comprises 60% to 40% by weight of tabular alumina granules and 40% to 60% by weight of adsorbent medium granules. Most preferably, the admixture comprises 50% by weight of tabular alumina granules and 50% by weight of adsorbent medium granules.

In the composite adsorbent granule, the tabular alumina particles and the adsorbent medium particles may be present in any proportion. However, preferably, the composite adsorbent granule comprises 5% to 95% by weight of tabular alumina particles and 95% to 5% by weight of adsorbent medium particles, wherein the weight is based on the weight of the composite adsorbent granule. More preferably, the composite adsorbent granule comprises 40% to 60% by weight of tabular alumina particles and 60% to 40% by weight of adsorbent medium particles. Most preferably, the composite adsorbent granule comprises 50% by weight of tabular alumina particles and 50% by weight of adsorbent medium particles.

The primary purpose of the adsorbent medium is to adsorb specific gases whereas the primary purpose of the tabular alumina is to improve heat retention. When the tabular alumina is in intimate contact with the adsorbent medium, the heat transfer rate is much improved.

Tabular alumina is a high density, nonporous, alpha crystalline alumina. Its granule density which is about 248.9 lb/ft³ (3987 kg/m³) is three times greater than that of microporous activated alumina which has a granule density of about 86 lb/ft³ (1378 kg/m³). Furthermore, its average specific heat, about 0.24 BTU/lb-° F., is twice that of steel shot. It is, therefore, a more preferable medium for retaining the heat of adsorption. Although it is within the scope of the present invention to use the admixture of tabular alumina granules and adsorbent medium granules throughout an adsorbent bed, additional benefits are achieved, and thus it is preferred, to incorporate the tabular alumina particles and the adsorbent medium particles in the same adsorbent granule. The composite adsorbent granule is preferred because separate granules tend to stratify or clarify based on their difference in granule density. Furthermore, the composite adsorbent granule which is comprised of tabular alumina particles and adsorbent medium particles is a higher density granule and allows for smaller beds to retain the heat of adsorption in the fractionation process. It also allows for higher bed design velocities or higher throughput. The velocity limitations in an adsorbent bed of granules are derived from fluidization considerations that are dependent upon granule density. Therefore, it is expected that the composite adsorbent granules comprising both the tabular alumina particles and the adsorbent medium particles, being of higher mass density, are able to withstand much higher fluid velocities. Additionally, by keeping the heat of adsorption in close proximity to the adsorbent particles by combining the adsorbent medium with the tabular alumina, less heat is lost to the environment through the chamber walls of the fractionator and the purge rate is reduced. For example, because of the heat losses in conventional pressure swing systems, the minimum required purge is about 15% greater than ideal. The composite adsorbent granules enable the process to be more isotropic and the purge rate can be reduced by about 5% from that required by conventional systems by using the present invention.

Tabular alumina that is suitable for use in the present invention includes, but is not limited to, alpha-alumina, alpha-monohydrate and alpha-alumina monohydrate or boehmite such as described in U.S. Pat. No. 4,946,666. Preferably, the tabular alumina medium is alpha alumina or corundum, which can be made by any known methods as well as any of the methods disclosed in “Aluminum Compounds,” Kirk-Othmer Encyclopedia of Chemical Technology, 2^{nd} Edition 1963, pages 41-58. Industrially, tabular alumina can be produced from the solidification of molten alumina (as are artificial sapphires), or from a sintering process at a temperature below the melting point of about 2040° C. and above 1300° C., or by the calcination of hydrated alumina at 1100° C. to 1300° C., or by autoclaving hydrated alumina in the presence of steam from 400° C. and upward. Pure forms are produced by sintering at high temperatures well over 1900° C. and slightly below 2035° C. Alpha alumina is preferred over alpha monohydrate because its density is higher, 248.9 lb/ft³ (3987 kg/m³) versus 188 lb/ft³ (3011 kg/m³). Tabular alumina is commercially available, for example, as T-60 Tabular Alumina, T-64 Tabular Alumina and T-162 Tabular Alumina Balls from Alcoa.

As discussed above, the composite adsorbent granule of the present invention has increased granule density, and this increased density provides for a higher specific flow rate without adsorbent dusting and lower granule attrition rates. The composite adsorbent granules also provide significantly higher heat capacity and greater volumetric specific heat than the typical adsorbent which is beneficial during the regeneration phase of the pressure swing or temperature swing process. Retention of the heat of adsorption is essential in the pressure swing process, but it is also beneficial in the thermal swing process. A thermal swing system designed to retain 10% of the heat of adsorption at the outlet end of the adsorbent bed will require only 90% of the heat normally required to regenerate the bed which significantly reduces the operating costs.

The adsorbent of the present invention can be produced by several methods. In the preferred method for the formation of the composite adsorbent granule, adsorbent medium particles and tabular alumina particles are added together in a balling machine (such as is used in the manufacture of alumina beads) with water and binder, if required. The percentage of particles added to the balling machine depends upon the desired blend. It is preferred to use small beads of tabular alumina as a seeding media in the balling machine. The adsorbent medium is agglomerated in layers over the tabular alumina until the desired granule size is achieved. In this manner, the adsorbent medium is retained in layers on the outside surface of the granule to enable rapid mass transfer and the high density tabular alumina is present in the center of the granule to better retain the heat of adsorption. With respect to the addition of a binder, activated alumina does not require a binder. However, in the balling of silica gel and molecular sieves, a binder is preferred to increase the physical strength of the product. Activated alumina or an adsorbent clay such as kaolin, montmorillonite or attapulgite can be used as a binder, typically in the range of 1% to 5% by weight.

Preferably the adsorbent medium particles are fine grain size. When the adsorbent medium is activated alumina, the grain size of the activated alumina is preferably between about 2 to 10 microns in diameter prior to granule forming, more preferably between about 4 to 7 microns. The same size range is desired in the manufacture of molecular sieves.

In another method for the formation of the composite adsorbent granule, a liquid solution comprising the adsorbent medium as well as aluminate (salt of alumina) or silicate (salt of silica) or both is mixed, and the tabular alumina particles are added to the liquid solution preferably prior to the precipitation or gelling of the adsorbent medium particles. For example, when molecular sieves are the adsorbent medium, both aluminate and silicate are present in the liquid solution. For example, when silica is the adsorbent medium, silicate is present in the liquid solution. For example, when alumina is the adsorbent medium, aluminate is present in the liquid solution. The tabular alumina serves as a seeding medium and provides nucleation sites for the formation of solid granules. In this method, the tabular alumina forms the center of the granule with the adsorbent medium surrounding it. In the case where silica gel is the adsorbent medium, it is preferred that the tabular alumina is added to the liquid silicic solution prior to gelling.

In yet another method for the formation of the composite adsorbent granule of the present invention, tabular alumina is added as fine particles to the adsorbent medium particles during the agglomeration process of producing larger granules such as by pelletizing, tabletizing, extruding, or balling. In this method, the granule is a homogenous admixture of tabular alumina and the adsorbent medium. In the cases of activated alumina and molecular sieves, it is preferred to add the tabular alumina in the form of micron size particles directly into the balling machine or into the wet adsorbent slurry prior to pelletizing or tabletizing.

In each of the above methods, the adsorbent particles are formed into various granule shapes and sizes. Typically, the granules range in size from about 1/16 of an inch (0.0015875 m) to about ¼ of an inch (0.00635 m) in diameter, with ⅛ of an inch (0.003175 m) being most common. Granulators and sieving screens may be used to produce irregular granules. Balling machines may be used to produce beaded adsorbents. Pelletizers may be used to produce desiccant in pellet form. Tabletizers may be used to produce tablets.

### PROPHETIC EXAMPLES

The following prophetic examples illustrate how the inventors would prepare the adsorbent of the present invention and how the inventors expect that the adsorbent would perform as compared to existing adsorbents. The following adsorbents have not actually been prepared or tested.

### Prophetic Example 1

The adsorbent of the present invention, wherein the adsorbent medium is activated alumina, can be prepared by adding fine tabular alumina (such as adding it with the water) immediately prior to precipitation of the double salt (aluminate) at 200° C. in U.S. Pat. No. 5,846,512 (col. 2, lines 17-24 and col. 3, lines 16-19).

### Prophetic Example 2

The adsorbent of the present invention can be prepared by introducing fine tabular alumina into a solution of benzene and aluminum triisoppropanolate (aluminate) in U.S. Pat. No. 4,292,295 (col. 4, lines 21-35) prior to precipitation.

### Prophetic Example 3

The adsorbent of the present invention can be prepared by adding tabular alumina as a seeding medium to a fluidized bed granulator where it assists to agglomerate the smaller particles into larger granules as in U.S. Pat. No. 4,797,271 (col. 3, lines 30-32).

### Prophetic Example 4

The adsorbent of the present invention can be prepared by adding tabular alumina to activated alumina particles in a ball grinder during the addition of the complexing agent set forth in U.S. Pat. No. 5,637,547 (col. 5, line 47-51). While ball grinding is preferred, numerous methods can be used as described in “Understand Size-Reduction Options” by Richard Kukla, Chem. Eng. Prog., May 1991.

### Prophetic Example 5

The adsorbent of the present invention, wherein the adsorbent medium is silica gel, can be prepared by adding tabular alumina fines to silica hydrogel (a liquid silicic solution) prior to setting or gelling such as in U.S. Pat. No. 4,256,682 (col. 2, lines 17-22).

### Prophetic Example 6

The adsorbent of the present invention can be prepared by adding tabular alumina to a mixture of silica gel particles and lubricant prior to its being compressed or compacted such as by adding the tabular alumina fines with the lubricant to the mixture in U.S. Pat. No. 4,256,682 (col. 3, line 66-68 and col. 4, lines 1-5).

### Prophetic Example 7

The adsorbent of the present invention, wherein the adsorbent medium is a molecular sieve, can be prepared by adding tabular alumina fines to aqueous reaction mixtures to synthesize the crystalline microporous compositions or molecular sieve often called zeolites. The tabular alumina fines can be added to the salt solution of sodium aluminate, sodium silicate, and sodium and potassium hydroxide in lieu of montmorillonite powders in the process set forth in U.S. Pat. No. 6,183,539 (col. 5, lines 36-45), prior to crystallization. The tabular alumina acts as a seeding medium for accelerating crystallization, and the particles produced by this process are of higher density as a result of the presence of the tabular alumina.

### Prophetic Example 8

The adsorbent of the present invention can be prepared by adding tabular alumina fines to the aqueous solution of the reaction mixture prior to heating and crystallizing in U.S. Pat. No. 5,296,208 (col. 2, lines 56-60).

### Prophetic Example 9

The adsorbent of the present invention can be prepared by adding tabular alumina fines to molecular sieve powder, along with the clay binder and water as in U.S. Pat. No. 4,818,508 (col. 2, lines 65-68). This thick paste media is formed into useable granule size by suitable shaping methods including extruding, spray drying, prilling, pilling, molding, casting, slip-casting, tableting, briqueting, and bead forming processes such as tumbling, drum rolling, Nauta mixing, and disk forming.

### Prophetic Example 10

The preferred method of preparing the adsorbent of the present invention is to feed preformed beads of tabular alumina into a balling drum and adding fine particles of adsorbent medium with water and optional binder until the desired bead size is attained. If the adsorbent medium is activated alumina, a binder is not needed. In balling where the adsorbent medium is silica gel or molecular sieves, a binder is preferred to increase the physical strength of the product. Activated alumina or an adsorbent clay such as kaolin, montmorillonite or attapulgite can be used as a binder, normally in the range of 1% to 5% by weight. The size of the initial bead of tabular alumina required to produce a bead of a specific weight fraction of tabular alumina and a given diameter can be determined by the following equation:

d=D[1+(T/A)(C⁻¹−1)]^{-⅓}

where

d=diameter of tabular alumina bead

D=diameter of granular product, consistent unit

T=granule density of tabular alumina

A=granule density of activated adsorbent, consistent unit

C=weight fraction of tabular alumina in the final granule

For example, to produce the adsorbent of the present invention with 25% by weight tabular alumina in ⅛ of an inch (0.003175 m) in diameter beads, the initial tabular alumina bead size is 0.05864 inches (0.001489 m) in diameter:

d=(⅛)[1+(248.9/86)(0.25⁻¹−1)]^{-⅓}

d=0.05864 inches (0.001489 m)

### Prophetic Comparative Example 1

It is expected that the adsorbent of the present invention will result in performance improvements in regenerable adsorbent fractionators as compared to existing adsorbents. These expected improvements are shown by comparing the expected performance of an adsorbent of the present invention with the performance of a standard adsorbent as set forth in “The Design of Pressure Swing Adsorption Systems: Test Results and Calculations for Air Dehydration (Chemical Engineering Progress, January 1989). In the reported test, a dual chamber pressure swing adsorption system was evaluated with adsorbent beds of 1.270 m (50 in) in length and 0.1206 m (4.75 in) in diameter with 0.0033 m beaded activated alumina. The inlet flow rate was 0.02211 kg/s, the operating pressure was 6.533×10⁵ Pa, the purge exhaust pressure was 1.413×10⁵ Pa and the inlet temperature was 294 K.

As illustrated below in the calculations, the adsorbent granules of the present invention comprising 50% activated alumina and 50% tabular alumina would have a bulk density that is 95% higher than standard activated alumina: 1496.7 kg/m³ (93.44 lb/ft³) versus 768.8 kg/m³ (48 lb/ft³). Due to its high density, the adsorbent of the present invention should be less prone to shifting and abrading in service and should be able to withstand much higher bed velocities than the standard adsorbent without an increase in granule attrition. Based upon the higher density, the granule size can be reduced to 0.00172 m in diameter (0.0677 in) while maintaining the same margin of attrition resistance. This should result in increased mass and heat transfer rates which tend to increase the product purity as indicated in Table 1 of the referenced document. A preferred method of utilizing the improved density is to allow higher velocities through the adsorbent bed. Based upon the same size beads as the standard media, the adsorbent of the present invention will allow a 40% increase in system flow rate while maintaining the same margin of attrition resistance as shown in the calculations. The same system with the improved adsorbent could be expected to treat 40% more air flow without damaging the adsorbent granules.

Calculation #1

The bulk density of the adsorbent of present invention (ρ_{b2}) was calculated for the adsorbent of the present invention comprising 50% by weight of activated alumina and 50% by weight of tabular alumina. The activated alumina has a granule density of 86 lb/ft³ (1378 kg/m³) and tabular alumina has a granule density of 248.9 lb/ft³ (3987 kg/m³). This bulk density was compared to the bulk density of activated alumina (ρ_{b1}), wherein activated alumina has a granule density (ρₚ₁) of 86 lb/ft³ (1378 kg/m³).

ρ_{b1}=ρₚ₁(1−ε) (1a)

ρ_{b2}=ρₚ₂(1−ε) (1b)

wherein

ρₚ₂=granule density=0.5(86 lb/ft³)+0.5(248.9 lb/ft³)=167.45 lb/ft³

ε=interstitial void fraction=0.442

ρ_{b2}=bulk density=167.45(1−0.442)=93.44 lb/ft³=1496.7 kg/m³

ρ_{b1}=bulk density=86 lb/ft³(1−.0442)=47.99 lb/ft³=768.7 kg/m³

ρ_{b2}/ρ_{b1}=1496.7/768.7=1.95

Thus, the adsorbent of the present invention based upon the above calculations is 95% denser than the standard media.

Calculation #2

The velocity limitations of the adsorbent of present invention with granules 0.0677 inches (0.00172 m) in diameter (Dₚ) was calculated.

E₁=1471(1−ε)²/(ε³Dₚ²g) (2)

wherein

ε=interstitial void fraction=0.442

g=gravitational acceleration in m/s²

Dₚ=diameter of adsorbent granule in m

E₁=1471(1−0.442)²/(0.442³*0.00172²*9.805)=18.29×10⁷

E₂=17.16(1−ε)/(ε³Dₚg) (3)

wherein

ε=interstitial void fraction=0.442

g=gravitational acceleration in m/s²

Dₚ=diameter of adsorbent granule in m

E₂=17.16(1−0.442)/(0.442³*0.00172*9.805)=6575

νₛ(max upflow)=−((μE₁)/(2ρₒE₂))+(((μE₁)/(2ρₒE₂))²+(ρ_{b}g/ρₒE₂))^{½} (4)

wherein

νₛ=axial velocity based on the total cross section in m/s

ρₒ=inlet density in kg/m³

μ=absolute viscosity in Pa·s

μE₁/(2ρₒE₂)=[(1.813×10⁻⁵)(18.29×10⁷)]/(2*7.744*6575)=0.03256

$$\begin{matrix}{v}_{s} = - 0.03256 + {( {( 0.03256 )}^{2} + ( ( 1496.7 * 9.805 ) / ( 7.744 * 6575 ) ) )}^{1 / 2} \\ = 0.51 \text{m/s}\end{matrix} \\ {ω}_{o} / A ( max upflow ) = ( {v}_{s} ) ( {ρ}_{o} ) \qquad ( 5 )$$

wherein

ωₒ=inlet mass flow rate in kg/s

A=total cross section of packed vessel in m²

$$\begin{matrix}{ω}_{o} / A ( limit upflow ) = {ω}_{o} / A ( max ) * 0.77 \\ = 4.0 * 0.77 = 3.04 \text{kg/s} \cdot {m}^{2} ( limit )\end{matrix} \qquad ( 6 )$$

Same limitations as standard media in larger bead form.

Calculation #3

The velocity limitations of adsorbent of the present invention with 0.13 inches (3.30×10^{31 3}m) in diameter granules were calculated.

μE₁/(2ρₒE₂)=[(1.813×10⁻⁵)(4.964×10⁷)]/(2*7.744*3426)=0.01696

$$\begin{matrix}{v}_{s} ( max upflow ) = - ( ( μ {E}_{1} ) / ( 2 {ρ}_{o} {E}_{2} ) ) + {( {( ( μ {E}_{1} ) / ( 2 {ρ}_{o} {E}_{2} ) )}^{2} + ( {ρ}_{b} g / {ρ}_{o} {E}_{2} ) )}^{1 / 2} \\ = - 0.01696 + {( {( 0.1696 )}^{2} + ( ( 1496.7 * 9.805 ) / ( 7.744 * 3426 ) ) )}^{1 / 2} \\ = 0.72696 \text{m/s}\end{matrix}$$

$$\begin{matrix}{ω}_{o} / A ( max upflow ) = ( {v}_{s} ) ( {ρ}_{o} ) \\ = 0.72696 \text{m/s} * 7.744 {\text{kg/m}}^{3} = 5.630 \text{kg/s} \cdot {m}^{2} ( max )\end{matrix}$$

$$\begin{matrix}{ω}_{o} / A ( limit upflow ) = {ω}_{o} / A ( max ) * 0.77 \\ = 5.630 \times 0.77 = 4.335 \text{kg/s} \cdot {m}^{2} ( limit )\end{matrix}$$

(4.335)/(3.079)=1.408 which is 40.8% higher than standard media.

Calculation #4

Heat transfer front movement with the adsorbent of the present invention was calculated.

νₕ=νₛ(ρₒ/ρ_{b})(cₒ/cₐ) (7)

wherein

νₕ=axial velocity of heating front in m/s

cₒ=specific heat of inlet in J/kg·K

cₐ=specific heat of adsorption phase in J/kg·K

νₕ=0.2497(7.744/1496.7)(1005/1005)=0.001292 m/s

Lₕ₂=(νₕ)(t) (8)

wherein

L_{h=length of heating front in m}

t=time in s

Lₕ₂=0.001292*300=0.3876 m

Lₕ₁(with standard media)=0.002515*300=0.7545 m

Calculation #5

The purge required with adsorbent of present invention was calculated.

$$\begin{matrix}Purge Factor = 1 + 0.15 ( {L}_{h2} / {L}_{h1} ) = 1 + 0.15 ( 0.3876 / 0.7545 ) \\ = 1.077 ( 7.7 \% extra purge required )\end{matrix} \qquad ( 9 )$$

ω₂(min.)=(purge factor)ωₒ(tₐ/tₚ)(p₃/pₒ) (10)

wherein

ω₂=mass flow rate of purge supply in kg/s

ωₒ=mass flow rate of inlet in kg/s

tₐ=time of adsorption phase in s

tₚ=time of purge in s

p₃=pressure of purge exhaust in Pa

pₒ=pressure of inlet in Pa

$$\begin{matrix}{ω}_{2} ( min . ) = ( 1.077 ) ( 0.02211 ) ( 300 / 270 ) ( ( 1.413 \times {10}^{5} ) / ( 6.533 \times {10}^{5} ) ) \\ = 5.723 \times {10}^{- 3} \text{kg/s} minimum purge required\end{matrix}$$

(5.723×10⁻³)/(6.112×10⁻³)=0.9363

Minimum purge is 6.4% less with adsorbent of the present invention.

Calculation #6

The bed length needed to retain the heat of adsorption with adsorbent of the present invention was calculated.

Lₕ=(ωₒ/A)cₒ[C/(Ua)+tₐ/(cₐρₐ)+2(Ctₐ/(Uacₐρₐ))^{½}] (11)

wherein

Lₕ=length of heating front in m

ωₒ=mass flow rate of inlet in kg/s

A=total cross section of packed vessel in m²

cₒ=specific heat of inlet in J/kg·K=1005 J/kg^{·K}

C=axial dispersion factor=1.48

a=external surface area per unit volume in m⁻¹=737.5 m⁻¹

cₐ=specific heat of adsorption phase in J/kg·K=1005 J/kg^{·K}

tₐ=time of adsorption phase in s=300 s

ρₐ=density of adsorbent in kg/m³=1496.7 kg/m³

U=overall heat transfer coefficient in W/m²·K=[hₒ⁻¹+hₐ⁻¹]⁻¹ (12)

hₒ=inlet heat transfer coefficient in W/m²·K=0.61ψνₛ(cₒρₒ)(N_{Pr})^{-⅔}(N_{Re})^{31 0.41} (13)

N_{Pr}=Prandtl number=0.72

N_{Re}=Reynolds number=(ωₒ/A)/(aμψ) (14)

μ=absolute viscosity in Pa·s

ψ=granule shape factor

hₐ=adsorption phase heat transfer coefficient in W/m²·K=60kₕ/(Dₚ²a) (15)

kₕ=adsorbent granule thermal conductivity in W/m·K

Dₚ=diameter of adsorbent granule in m

ωₒ/A=0.02211/((0.1206)²(107/4))=1.9355 kg/s·m²

N_{Re}=(1.9355)/(737.5*1.828×10⁻⁵*0.97)=148

h₀=0.61(0.97)(0.2497)(1005×7.744)(0.72)^{-⅔}(148)^{-0.41}=184.5 W/m²·K

hₐ=60(0.1731)/(3.30×10⁻³)²(737.5)=1293.2 W/m²·K

U=[(1/184.5)+(1/1293.2)]⁻¹=161.5 W/m²·K

$$\begin{matrix}{L}_{h} = ( 1.9355 ) ( 1005 ) ( ( 1.48 / ( 161.5 * 737.5 ) ) + ( 300 ) / ( 1005 * 1496.7 ) + \\ 2 ( {( ( 1.48 * 300 ) / ( 161.5 * 737.5 * 1005 * 1496.7 ) )}^{1 / 2} ) ) \\ = 1945.2 [ ( 1.2426 \times {10}^{- 5} ) + ( 19.944 \times {10}^{- 5} ) + ( 9.956 \times {10}^{- 5} ) ] \\ = 1945.2 [ 0.0003114 ] = 0.6058 m ( required to retain heat of adsorption )\end{matrix}$$

0.6058 m/1.049 m=0.58 which is 42% less length required to retain heat of adsorption

Calculation #7

The bed length to retain the heat of adsorption with the adsorbent of the present invention and a 40% higher inlet flow rate was calculated.

$$\begin{matrix}{ω}_{o} / A = 1.4 \times 1.9355 \\ = 2.710 \text{kg/s} \cdot {m}^{2}\end{matrix}$$

$$\begin{matrix}{v}_{s} = 1.4 \times 0.2497 \\ = 0.3496 \text{m/s}\end{matrix}$$

N_{Pr}=0.72

N_{Re}=1.4×148=207.2

hₒ=0.61(97)(1005*7.744)(0.72)^{-⅔}(207.2)^{-0.41}(0.3496)=225.0

U=[(1/225)+(1/1293.2)]⁻¹=191.65

$$\begin{matrix}{L}_{h} = ( 2.710 ) ( 1005 ) [ ( 1.48 ) / ( 191.65 * 737.5 ) + 300 / ( 1005 * 1496.7 ) + \\ 2 ( {( ( 1.48 * 300 ) / ( 191.65 * 737.5 * 1005 * 1496.7 ) )}^{1 / 2} ) ] \\ = 2623.6 [ ( 1.0471 \times {10}^{- 5} ) + ( 19.944 \times {10}^{- 5} ) + ( 9.140 \times {10}^{- 5} ) ] \\ = 0.8206 m required to retain heat of adsorption\end{matrix}$$

A further expected improvement with the adsorbent of the present invention is in the velocity of the heat transfer front during the adsorption process. Because of the higher volumetric heat capacity of the adsorbent of the present invention, much more of the heat of adsorption should be retained within the adsorbent granule where it is generated and less should be transferred downstream. As a result, the velocity of the heat transfer front should be reduced from 0.002515 m/s (5.94 in/min) to 0.001292 m/s (3.052 in/min). In 300 seconds of adsorption time, the heat transfer front should travel only 0.3876 m (15.3 inches) with the adsorbent of the present invention versus 0.7545 m (29.7 inches) with the standard media. Since less of the chamber wall is heated by the heat of adsorption in 300 seconds, the extra purge required by can be reduced. Instead of an extra 15% of purge, the minimum extra purge required to sustain the process is 7.7% with the adsorbent of the present invention in the same pressure-swing system.

The minimum length of bed required to retain the heat of adsorption including the low temperature region of the leading edge is reduced from 1.049 m (41.3 inches) to 0.6058 meters (23.85 inches) as shown in the calculations based upon using the adsorbent of the present invention with the same inlet flow rate. If the inlet flow rate is increased by 40%, which is permitted by the increased granule density, the minimum length of bed required to retain the heat of adsorption is 0.8206 meters (32.3 inches) which is 22% less than with the standard media with less flow rate.

Based on the expected improvement in abrasion resistance and shortened heat transfer length, a pressure swing adsorption system comprising the adsorbent of the present invention can use beds of 0.994 m (39.1 inches) in length instead of beds of 1.27 m (50 inches) in length, a 22% reduction, and the flow rate should be able to be increased 40% to 0.03095 kg/s without reducing the safety of margin used in the original system design with standard adsorbent.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

We claim:

1. An adsorbent bed comprising an admixture of tabular alumina granules and adsorbent medium granules.

2. The adsorbent bed as claimed in claim 1, wherein the adsorbent medium granules are selected from the group consisting of activated alumina, silica gel, molecular sieve, adsorbent clay, activated carbon and a mixture thereof.

3. The adsorbent bed as claimed in claim 1, wherein the tabular alumina granules are present in an amount of 95% to 5% by weight and the adsorbent medium granules are present in an amount of 5% to 95% by weight, wherein the percent by weight is based on the weight of the adsorbent.

4. The adsorbent bed as claimed in claim 3, wherein the tabular alumina granules are present in an amount of 40% to 60% by weight and the adsorbent medium granules are present in an amount of 60% to 40% by weight, wherein the percent by weight is based on the weight of the adsorbent.

5. The adsorbent bed as claimed in claim 4, wherein the tabular alumina granules are present in an amount of 50% by weight and the adsorbent medium granules are present in an amount of 50% by weight, wherein the percent by weight is based on the weight of the adsorbent.

6. A composite adsorbent granule comprising tabular alumina particles and adsorbent medium particles.

7. The composite adsorbent granule as claimed in claim 6, wherein the adsorbent medium particles are selected from the group consisting of activated alumina, silica gel, molecular sieve, adsorbent clay, activated carbon and a mixture thereof.

8. The composite adsorbent granule as claimed in claim 6, wherein the tabular alumina particles are present in an amount of 95% to 5% by weight and the adsorbent medium particles are present in an amount of 5% to 95% by weight, wherein the percent by weight is based on the weight of the composite adsorbent granule.

9. The composite adsorbent granule as claimed in claim 8, wherein the tabular alumina particles are present in an amount of 40% to 60% by weight and the adsorbent medium particles are present in an amount of 60% to 40% by weight, wherein the percent by weight is based on the weight of the composite adsorbent granule.

10. The composite adsorbent granule as claimed in claim 9, wherein the tabular alumina particles are present in an amount of 50% by weight and the adsorbent medium particles are present in an amount of 50% by weight, wherein the percent by weight is based on the weight of the composite adsorbent granule.

11. A composite adsorbent granule having a center and a surface surrounding the center of the granule, wherein the center of the granule comprises tabular alumina particles and the surface of the granule comprises adsorbent medium particles other than tabular alumina particles.

12. The composite adsorbent granule as claimed in claim 11, wherein the adsorbent medium particles are selected from the group consisting of activated alumina, silica gel, molecular sieve, adsorbent clay, activated carbon and a mixture thereof.

13. The composite adsorbent granule as claimed in claim 11, wherein the tabular alumina particles are present in an amount of 95% to 5% by weight and the adsorbent medium particles are present in an amount of 5% to 95% by weight, wherein the percent by weight is based on the weight of the composite adsorbent granule.

14. The composite adsorbent granule as claimed in claim 13, wherein the tabular alumina particles are present in an amount of 40% to 60% by weight and the adsorbent medium particles are present in an amount of 60% to 40% by weight, wherein the percent by weight is based on the weight of the composite adsorbent granule.

15. The composite adsorbent granule as claimed in claim 14, wherein the tabular alumina particles are present in an amount of 50% by weight and the adsorbent medium particles are present in an amount of 50% by weight, wherein the percent by weight is based on the weight of the composite adsorbent granule.

16. A regenerable adsorbent fractionator having at least one adsorbent bed, wherein the adsorbent bed comprises the adsorbent of claim 1.

17. A regenerable adsorbent fractionator having at least one adsorbent bed, wherein the adsorbent bed comprises the composite adsorbent granules of claim 6.

18. A regenerable adsorbent fractionator having at least one adsorbent bed, wherein the adsorbent bed comprises the composite adsorbent granules of claim 11.

19. A method of preparing a composite adsorbent granule wherein the composite adsorbent granule comprises tabular alumina particles and adsorbent medium particles, the method comprising adding the tabular alumina particles to a balling machine as a seeding medium together with the adsorbent medium particles, water and optional binder to agglomerate the adsorbent medium particles in layers over the tabular alumina particles.

20. The method as claimed in claim 19, wherein the adsorbent medium is selected from the group consisting of activated alumina, silica gel, molecular sieve, adsorbent clay, activated carbon and a mixture thereof.

21. The method as claimed in claim 19, wherein the adsorbent medium is activated alumina.
